(19) United States
(12) Patent Application Publication
(10) Pub. No.: US 2006/0154519 A1
(43) Pub. Date: Jul. 13, 2006

(54) Ram connector and method of use thereof

(76) Inventor: Noah P. Montena, Syracuse, NY (US)

Correspondence Address: SCHMEISER, OLSEN & WATTS, 22 CENTURY HILL DRIVE, SUITE 302, LATHAM, NY, 12110, US

(21) Appl. No.: 11/031,739

(22) Filed: Jan. 7, 2005

(51) Int. Cl. H01R 9/05

(52) U.S. Cl. 439/578

(57) ABSTRACT

A coaxial cable compression connector is provided, wherein the connector comprises a connector body a post and a coupler, and further wherein the cable is compressed onto the connector such that traction forces between the cable, connector body and post provide a secure grip and substantial seal on the cable when the connector is installed and fastened together.

### BACKGROUND OF INVENTION

1. Technical Field

This invention relates generally to the field of connectors for coaxial cables. More particularly, this invention provides for a compression connector and method of use thereof.

2. Related Art

Cable communications have become an increasingly prevalent form of electromagnetic information exchange and coaxial cables are common conduits for transmission of electromagnetic communications. Accordingly, coaxial cables are provided to facilitate communication exchange in a variety of applications and environments. Depending on the intended use and performance requirements of a particular segment of a cable communication system, there is a broad range of possible cable designs having varied braid, foil, dielectric, moisture inhibitor, center conductor, and outer jacket combinations. This variety gives rise to numerous difficulties in creating a connector which provides an adequate mechanical, electrical, and environmentally protected termination of the cable, while still remaining easy to install and operate.

To accommodate the variety of possible cables many connectors employ a compression member or a compression groove intended secure a connection by effecting a substantially uniform circular distribution of grasping force on the cable. However, use of a compression member or a compression groove increases the part count and/or complicates the installation process of the connectors. Other connectors utilize designs that rely on snap-fitting components to securely install the connector. However, connectors relying on snap-fitting designs increase the difficulty of manufacture and complexity of operation of the connectors. Moreover, connectors employing a compression member or a compression groove and/or utilizing snap-fitting designs require additional force during installation to compress the connector and/or snap-fit the connector components to thereby effect a secure connection.

Accordingly, there is a need in the field of coaxial cable connectors for an improved connector design.

### SUMMARY OF INVENTION

The present invention provides an apparatus for use with coaxial cable connections that offers improved reliability.

A first general aspect of the invention provides a coaxial cable connector comprising a coupler, including an internal surface feature. The connector may further comprise a post, having an external surface feature configured to operably engage the internal surface feature of the coupler. Furthermore, the connector may comprise a connector body, including a collar for slidably engaging the post, the connector body operatively securing the cable as the cable is received and compressed against the connector body and the post, wherein the connector body is positioned along the post in a first pre-installed position such that during installation the connector body slidably moves toward the coupler to a second installed position where the connector body is separated from the external feature of the post by the internal surface feature of the coupler.

A second general aspect of the invention provides a coaxial cable connector comprising a coupler, having an extended annular sleeve, wherein an internal surface of the coupler includes a surface feature. The connector may further comprise a post, having an external surface feature configured to operably engage the surface feature of the coupler. Furthermore, the connector may comprise a connector body, having an internal surface and an external surface, the external surface configured to slidably engage at least a portion of the extended annular sleeve, and the internal surface slidably positioned on the post during installation, wherein the surface feature of the coupler prevents the connector body from engaging the external feature of the post.

A third general aspect of the invention provides a coaxial cable connector comprising a connector body, having a first end and a second end, the second end configured for receiving the cable. The connector may further comprise a post operating with a coupler, wherein the post is slidably mounted with the connector body in a first pre-installed position, and wherein axial movement of said post and coupler is restrained in both directions with respect to said connector body without engagement by the post or coupler with an external protrusion on the first end of the connector body when the post and coupler are slidably moved to a second installed position causing the cable to compress against the post and connector body securely retaining the cable.

A fourth general aspect of the invention provides a coaxial cable connector comprising a post, having a flanged end. The connector may further comprise a coupler, having an elongated aperture partially terminated by a surface feature, wherein the surface feature contacts the post flange. Furthermore, the connector may comprise a connector body, having a section proximate the coupler and a section distal the coupler when installed on the cable, the proximate section having a first axial opening with a first diameter and the distal section having a second axial opening with a second diameter larger than the first diameter. Still further, the connector may comprise means for facilitating a final secure positioning of the coupler onto the connector body such that the coupler engages a portion of the connector body accommodating the larger second diameter.

A fifth general aspect of the invention provides a method for fastening a connector with a coaxial cable, the method comprising providing a connector, including a post having an external surface feature, a connector body having internal surface and an external surface, the internal surface slidably positioned on the post during installation, and a coupler configured with an extended annular sleeve and an internal surface feature, the internal surface feature configured to operably engage the external surface feature of the post and separate the connector body from the external surface feature of the post. The method may further comprise positioning the post onto a portion of the cable. Furthermore, the method may comprise compressing the connector to facilitate slidable movement of the external surface of the connector body into at least a portion of the extended annular sleeve of the coupler as the cable is pushed onto the post rendering a compression seal of the cable between the internal surface of the connector body and the post.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a cut-away perspective view of a first embodiment of a connector in a first pre-installed position, in accordance with the present invention;

FIG. 2 depicts a sectional side view of a first embodiment of a connector in a second installed position, in accordance with the present invention;

FIG. 3 depicts a cut-away perspective view of a second embodiment of a connector, in accordance with the present invention;

FIG. 4 depicts a cut-away perspective view of a third embodiment of a connector, in accordance with the present invention;

FIG. 5 depicts a cut-away perspective view of a fourth embodiment of a connector, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

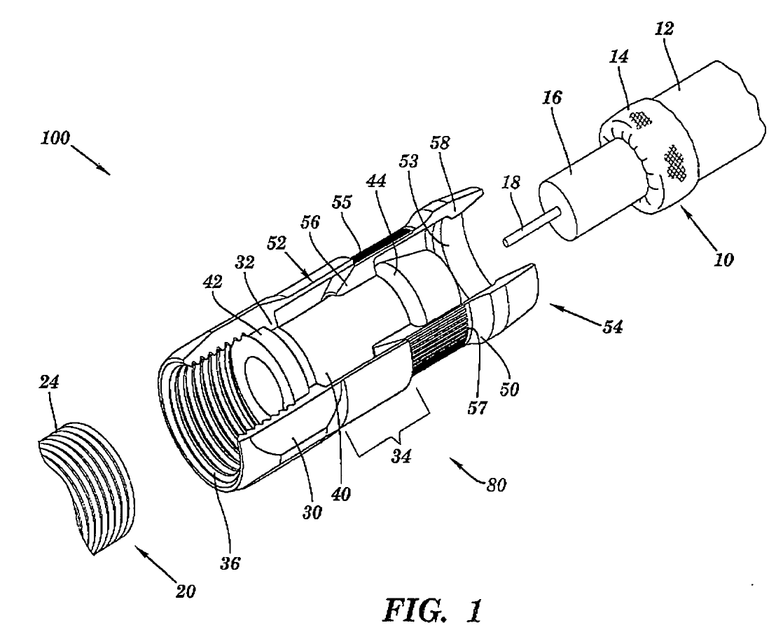

Referring to the drawings, FIG. 1 depicts a cut-away perspective view of an embodiment of a connector 100 in a first pre-installed position 80, in accordance with the present invention. The connector 100 may include a coaxial cable 10 having a protective outer jacket 12, a conductive grounding shield 14, an interior dielectric 16 and a center conductor 18. The coaxial cable 10 may be prepared as embodied in FIG. 1 by removing the protective outer jacket 12 and drawing back the conductive grounding shield 14 to expose a portion of the interior dielectric 16. Further preparation of the embodied coaxial cable 10 may include stripping the dielectric 16 to expose a portion of the center conductor 18. The protective outer jacket 12 is intended to protect the various components of the coaxial cable 10 from damage which may result from exposure to dirt or moisture and from corrosion and may be formed of various materials suitable for accomplishing the intended protection. Moreover, the protective outer jacket 12 may serve in some measure to secure the various components of the coaxial cable 10 in a contained cable design that protects the cable 10 from damage related to movement during cable installation. The conductive grounding shield 14 may be comprised of conductive materials suitable for providing an electrical ground connection. Various embodiments of the shield 14 may be employed to screen unwanted noise. For instance, the shield 14 may comprise a metal foil wrapped around the dielectric 16, or several conductive strands formed in a continuous braid around the dielectric 16. Combinations of foil and/or braided strands may be utilized wherein the conductive shield 14 may comprise a foil layer, then a braided layer, and then a foil layer. Those in the art will appreciate that various layer combinations may be implemented in order for the conductive grounding shield 14 to effectuate an electromagnetic buffer helping to prevent ingress of environmental noise that may disrupt broadband communications. The dielectric 16 may be comprised of materials suitable for electrical insulation. It should be noted that the various materials of which all the various components of the coaxial cable 10 are comprised should have some degree of elasticity allowing the cable 10 to flex or bend in accordance with traditional broadband communications standards, installation methods and/or equipment. Moreover, the cable 10 may include a flooding compound or viscous sticky moisture inhibitor to prevent the capillary migration of water inside the cable 10 should a puncture or other leak occur and depending upon the performance requirements for the cable 10. It should further be recognized that the radial thickness of the coaxial cable 10, protective outer jacket 12, conductive grounding shield 14, interior dielectric 16 and/or center conductor 18 may vary based upon generally recognized parameters corresponding to broadband communication standards and/or equipment.

Referring further to FIG. 1, the connector 100 may also include a coaxial cable interface port 20. The coaxial cable interface port 20 may include a receptacle for receiving a portion of a coaxial cable center conductor 18 sufficient to make adequate electrical contact. The coaxial cable interface port 20 may further comprise a threaded exterior surface 24. However, various embodiments may employ a smooth as opposed to threaded exterior surface. It should be recognized that the radial thickness and/or the length of the coaxial cable interface port 20 may vary based upon generally recognized parameters corresponding to broadband communication standards and/or equipment. Moreover, the pitch and height of threads which may be formed upon the threaded exterior surface 24 of the coaxial cable interface port 20 may also vary based upon generally recognized parameters corresponding to broadband communication standards and/or equipment. Furthermore, it should be noted that the interface port 20 may be formed of a single conductive material, multiple conductive materials, or may be configured with both conductive and non-conductive materials corresponding to the port's 20 electrical interface with a connector 100. Further still, it will be understood by those of ordinary skill that the interface port 20 may be embodied by a connective interface component of a communications modifying device such as a signal splitter, a cable line extender, a cable network module and/or the like.

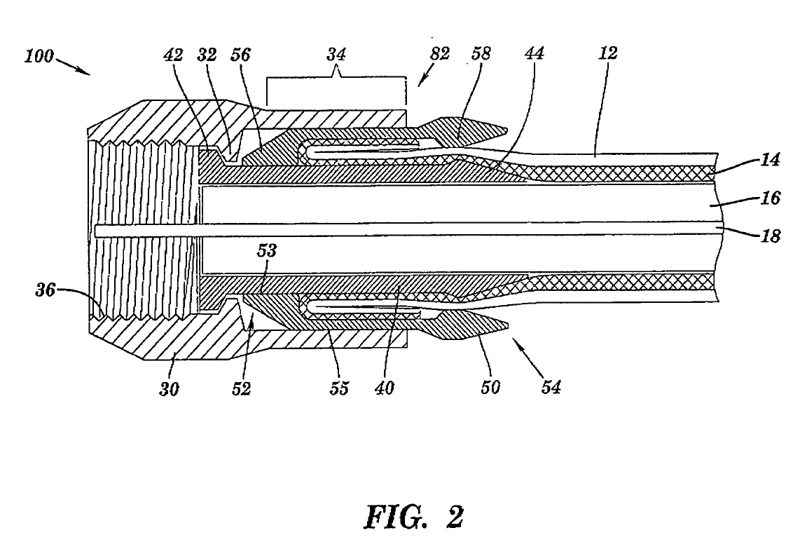

Referring still further to FIG. 1, an embodiment of the connector 100 may comprise a coupler 30 having an internal surface feature 32. The internal surface feature 32 may be a protrusion extending from the internal surface of the coupler or a mating recess. For example, the internal surface feature 32 may be an annular ridge, lip or rim, a bump, a bulge, a jutting, a protuberance, a knob, a castellation, and/or other like feature for mating with the coupler 30. Furthermore, the coupler 30 may have an extended annular sleeve 34. The extended annular sleeve 34 may frame an elongated aperture extending from an edge of the coupler 30 and being partially terminated by the internal surface feature 32 of the coupler 30. The partial terminus of the elongated aperture may prevent axial movement in one direction of a connector body 50 as the extended annular sleeve 32 is pushed over at least a portion of an external surface 55 of the connector body 50 while the connector body 50 is received within the elongated aperture framed by the extended annular sleeve 34 of the coupler 30 (shown in FIG. 2). Additionally, the coupler 30 may include a threaded internal surface 36. The threaded internal surface 36 may facilitate coupling of the coupler 30 to an interface port 20 having complimentary external threading 24. However, those in the art should appreciate that the coupler may have an internal surface configured with no threads or configured with other surface features corresponding to surface features on an interface port 20 thereby facilitating attachment of the coupler 30 with a correspondingly configured interface port 20. The coupler 30 may be formed of conductive materials facilitating grounding through the nut. Accordingly the coupler 30 may be configured to extend an electromagnetic buffer by electrically contacting conductive surfaces of an interface port 20 when a connector 100 (shown in FIG. 1) is advanced onto the port 20. In addition, the coupler 30 may be formed of non-conductive material and function only to physically secure and advance a connector 100 onto an interface port 20. Moreover, the coupler 30 may be formed of both conductive and non-conductive materials. For example the internal lip 32 may be formed of a polymer, while the remainder of the nut 30 may be comprised of a metal or other conductive material. In addition, the coupler 30 may be formed of metals or polymers or other materials that would facilitate a rigidly formed body. Manufacture of the coupler 30 may include casting, extruding, cutting, turning, tapping, drilling, injection molding, blow molding, or other fabrication methods that may provide efficient production of the component.

With continued reference to FIG. 1, an embodiment of the connector 100 may comprise a post 40. The post 40 may comprise an external surface feature 42 configured to operate with the internal lip 32 of coupler 30 thereby facilitating axial movement of the post 40 with respect to the coupler 30 and preventing axial movement of the post 40 beyond the internal lip 32 of the coupler 30. The external surface feature 42 may be a flange extending from the edge of the post, or the external surface feature 42 may be an annular ridge, lip or rim, a protrusion, a bump, a bulge, a jutting, a protuberance, a knob, a castellation, and/or other like feature extending outwardly from the external surface of the post 40 or a mating recess. Additionally, an end of the post 40 should be configured to mount with a connector body 50 in a first pre-installed position 80 of connector 100. Mounting of the post 40 in a first pre-installed position 80 may comprise the insertion of the post 40 into a portion of the connector body 50 such that an external surface of the post 40 slidably engages an internal surface 53 of the connector body 50. The post 40 should be formed such that portions of a prepared coaxial cable 10 including the dielectric 16 and center conductor 18 may pass axially into and/or through the body of the post 40. Moreover, the post 40 should be dimensioned such that the post 40 may be inserted into an end of the prepared coaxial cable 10, around the dielectric 16 and under the protective outer jacket 12 and conductive grounding shield 14. The post may include a bulge 44, such as an annular bump or other external feature configured to facilitate snug insertion into the coaxial cable 10. The bulge 44 may also assist in the compression connection of the connector 100 with the cable 10 by increasing the traction force on the cable 10 as it is retained in a second installed position 82 on the connector 100 (shown in FIG. 2). Accordingly, where an embodiment of the post 40 may be inserted into an end of the prepared coaxial cable 10 and under the drawn back conductive grounding shield 14, substantial physical and/or electrical contact with the shield 14 may be accomplished thereby facilitating grounding through the post 40. The post 40 may be formed of metals or other conductive materials that would facilitate a rigidly formed body. In addition, the post 40 may also be formed of non-conductive materials such as polymers or composites that facilitate a rigidly formed body. In further addition, the post may be formed of a combination of both conductive and non-conductive materials. For example, a metal coating or layer may be applied to a polymer or other non-conductive material. Manufacture of the post 40 may include casting, extruding, cutting, turning, drilling, injection molding, spraying, blow molding, or other fabrication methods that may provide efficient production of the component.

Referring further to FIG. 1, an embodiment of a connector 100 may comprise a connector body 50. The connector body 50 may include a first end 52, the first end 52 being proximate the coupler 30 when the connector 100 is installed on the coaxial cable 10, and opposing second end 54, the second end being distal the coupler 30 when the connector 100 is installed. The first end 52 may be configured with a collar 56 to slidably receive the post 40 as the connector body 50 is mounted on the post 40 in a first pre-installed position 80 such that an internal surface 53 of the connector body 50 engages the post 40. The collar 56 may reside in the section of the connector body 50 being proximate the coupler 30 when installed and may have a first axial opening having a first diameter configured to receive the post 40. In addition, the connector body 50 may be geometrically and dimensionally defined such that an external surface 55 of the connector body 50 may slidably engage a surface of the elongated aperture of the coupler 30 as a portion of the connector body 50 is slidably maneuvered into the extended annular sleeve 34 of the coupler 30. The distal second end of the connector body may have a second axial opening larger than the first axial opening of the first end 52, wherein the distal section of the connector body has a second axial opening having a diameter configured to receive the prepared coaxial cable 10. Moreover, the connector body may include an internal surface feature 58 such as a bulge, an annular bump or other surface feature configured to facilitate snug insertion of the coaxial cable 10 as received into the connector body. The internal surface feature 58 may also assist in the compression connection of the connector 100 with the cable 10 by increasing the traction force on the cable 10 as it is retained in a second installed position 84 on the connector 100 (shown in FIG. 2). Further, the connector body 50 may include at least one external surface feature 57 configured to enhance engagement of the extended annular sleeve 34 of the coupler 30 with the connector body 50 when the connector is in a second installed position 84. The connector body 50 may be formed of materials such as, polymers, metals or composite materials. Further, the connector body 50 may be formed of conductive or non-conductive materials or a combination thereof. Manufacture of the connector body 50 may include casting, extruding, cutting, turning, drilling, injection molding, spraying, blow molding, or other fabrication methods that may provide efficient production of the component.

Referring further to the drawings, FIG. 2 depicts a sectional side view of an embodiment of a connector in a second installed position 82, in accordance with the present invention. The connector 100 may be configured such that the coaxial cable 10 may be pushed onto the post 40 in a manner rendering the center conductor 18 and dielectric 16 surrounded by a portion of the post 40. Further, the connector 100 may be configured such that the conductive grounding sheath 14, protective outer jacket 12 and possibly a flooding compound or other moisture inhibitor of inhibitor of the coaxial cable 10 may surround a portion of the post 40 as the cable 10 is pushed onto the connector 100. Progression of the post 40 under the conductive grounding sheath 14, possible flooding compound or moisture inhibitor, and protective outer jacket 12 layers of the cable 10 causes the layers to expand and be forced against the internal surface 53 of the connector body 50. The tight disposition of the cable 10 between the outside of the post 40 and the internal surface 53 of the connector body 50 provides the traction force required to prevent the cable 10 from pulling out of the connector 100. Moreover, the snug placement of the cable 10 around the post 40 provides a substantially uniform circular distribution of grasping force on the cable 10 and facilitates a secure and substantially sealed binding of the cable 10 to the connector 100. The tightness of the connection between the connector body 50, the cable 10 and the post 40 may be enhanced by the internal surface feature 58 of the connector body 50 working in conjunction with the bulge 44 of the post 40 to increase the compression grip on the cable 10 when the cable 10 is positioned in a second installed position 82. However, the internal surface feature 58 and/or the bulge 44 are not requisite features necessary for secure fastening of the cable 10. The compression of portions of the cable 10 snugly between internal surface 53 of the connector body 50 and the post 40 renders the traction force needed to securely fasten the cable 10 to the connector 100.

Where the cable 10 is securely fastened and compressed between the post 40 and the connector body 50 when the connector 100 is in a second installed position 82, the cable 10, post 40 and connector body 50 are securely positioned both axially and rotationally with respect to each other. In addition, when the connector 100 is in a second installed position 82, the axial positioning of the coupler 30 is also secured in relation to the cable 10, post 40 and connector body 50 because axial movement of the coupler 30 is hindered by the location of the internal surface feature 32 of the coupler 30 with respect to the external surface feature 42 of the post 40 and the collar 56 on the first end 52 of the connector body 50. The external surface feature 42, such as a flange, of the post 40 prevents the coupler 30 from moving toward the post 40 because the internal surface feature 32 of coupler 30 gets in the way and precludes axial movement of the coupler 30. Further, the collar 56 on the first end 52 of the connector body 50 prevents the coupler 30 from moving toward the connector body 50 because the internal surface feature 32 of the coupler 30 gets in the way and precludes axial movement of the coupler 30. Notably, the coupler 30 does not snap-fit with, interlock with, or connectively engage the collar 56 on the section of the connector body 50 proximate the coupler 30. The collar 56 of the connector body 50 does not prevent the coupler 30 from becoming unconnected with the connector body 50 when the connector 100 is in a second installed position. Rather, contact which may result between the coupler 30 and the collar 56 of the connector body 50 merely prevents the coupler 30 from axially advancing farther onto the connector body 50 further increasing the physical connection of the coupler 30 with the connector body 50. The connector body 50 has a first axial opening with a first diameter similar to the diameter of the post 40 such that the internal surface 53 of the collar 56 slidably engages the post 40. Hence, if there were no traction forces existent between the connector body 50 and the post 40 when the cable 10 is fastened to the connector 100 in a second installed position 82, axial movement of the coupler 30 toward the connector body 50 would correspondingly move the connector body 50 because the internal surface feature 32 of the 32 of the coupler 30 would abut the collar 56 of the connector body 50 causing it to reactively move in relation to the coupler 30. Accordingly, axial movement or the post 40 and the coupler 30 is restrained in both directions with respect to the connector body 50 without engagement by the post 40 or coupler 30 of an external protrusion, such as a lip or flange, extending from the first end 52 of the connector body 50, when the post 40 and coupler 30 are slidably moved to a second installed position 82 causing the cable 10 to compress against the post 40 and connector body 50 securely retaining the cable 10.

Connective engagement of the coupler 30 and connector body 50 occurs at a location of the connector 100 where a portion of the external surface 55 of the connector body 50 slidably engages a portion of the elongated aperture framed by the extended annular sleeve 34 of the coupler 30. The portion of the external surface 55 of the connector body 50 that engages the coupler 30 is the portion that accommodates the larger axial opening of the connector body 50 having a second diameter extending from the second end 54 of the connector body 50, wherein the second diameter is large enough to receive the coaxial cable 10. Hence, the coupler 30 engages the connector body 50 at a location where the external surface 55 of the connector body 50 conforms to a diameter sufficient to retain the cable 10 when the connector 100 is in a second installed position 82.

Referring still further to FIG. 2, while the coupler 30 is axially secured with respect to the cable 10, post 40 and connector body 50 when the connector 100 is in a second installed position 82, the coupler 30 is not rotationally secured with respect to the cable 10, post 40 and connector body 50. The coupler 30 is free to spin. The connective engagement of the coupler 30 with the external surface 53 of the connector body 50 facilitates relatively unhindered rotational movement of the coupler 30. There are no physical features pertaining to components of the connector 100 which prohibit the rotational movement of the coupler 30 when the connector 100 is in a second installed position 82. There are, however, physical features utilized to axially separate various components of the connector 100. For example, the connector body 50 is spaced apart from the external surface feature 42 of the post 40 by the internal surface feature 32 of the coupler 30. This separation assists the rotational mobility of the coupler 30 because the coupler 30 is not compressed or snap-fit over the collar 56 of the connector body to establish a proximal seal wherein the connector body 50 engages the external surface feature 42 of the post 40. Rather, the seal is facilitated by the engagement of the external surface 55 of the connector body 50 and the extended annular sleeve 34 of the coupler 30. Thus, when the connector 100 is in a second installed position 82, the connector body 50 is separated from the external surface feature 42, such as a flange, of the post 40. The rotational mobility of the coupler 30 having a threaded internal surface 36 may allow the connector 100 to be advanced onto an interface port 20 (shown in FIG. 1).

The connector 100 may be finally secured in a second installed position 82, such that the coupler 30 engages a portion of the connector body 50 accommodating the second diameter of the connector body 50, the second diameter extending from the second end 54 of the connector body 50 and being large enough to receive the coaxial cable 10. Means for accomplishing the final secure positioning may include the operation of the post 40 and connector body 50 on the cable 10 as the cable 10 is compressed therebetween, such that the cable 10, post 40 and connector body 50 are maintained in a secure position with respect to each other due to traction forces resulting from the compression, and wherein the coupler 30 is pushed onto a portion of the connector body 50 accommodating the second diameter and is secured by the abutment of the internal surface feature 42 of the coupler 30 with the external surface feature 42 of the post 40.

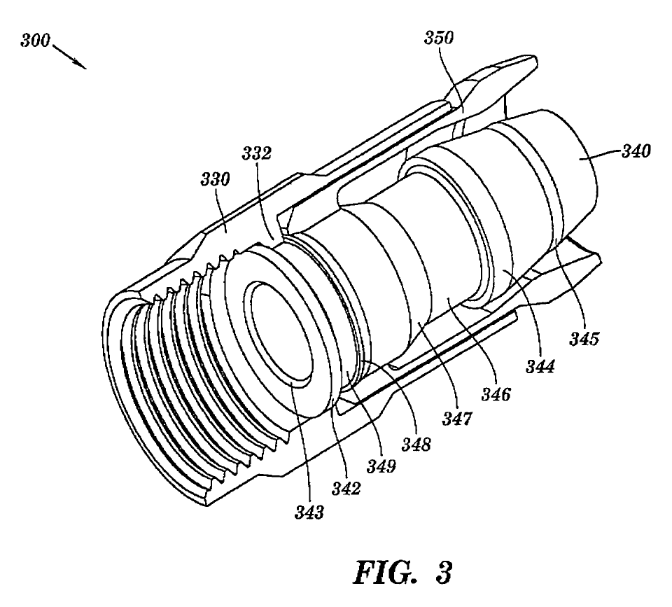

With further reference to the drawings, FIG. 3 depicts a cut-away perspective view of an embodiment of a connector 200, in accordance with the present invention. The connector 300 may include a coupler 330, a post 340 and a connector body 350. The post 340 may have an external surface feature 342, such as a flange. The interior portion of the external surface feature 342, such as a flange, may include a chamfer 343. Further, the post 340 may have a bulge 344, such as an annular bump or other external feature configured to facilitate snug insertion of the post 340 into the coaxial cable 10 (shown in FIGS. 1-2). The bulge 344 may be configured with an annular bump 345 to enhance engagement of the post 340 with the cable 10. Additionally, the bulge 344 may serve to axially retain the connector body 350 on the post 340 when the connector body is initially placed on the post 340 prior to installation of the connector 300. Moreover, the post 340 may have an external depression 346, wherein a portion of the connector body 350 may be loosely positioned prior to installation. Still further, the post 340 may have a tapered surface 347 adjoining the external depression 346, so that the connector body 350 may more closely engage the post 340 during installation. Furthermore, the post 340 may have a sloped ridge 348 facilitating a tighter engagement of the connector body 350 with the coupler 330. In addition, the post 340 may have an annular detent 349 into which an internal surface feature 332 of the coupler may be positioned prior to or during installation. Placement of the internal surface feature 332 of feature 332 of the coupler 330 into the annular detent 349 of the post 340 may assist the installation operation of the connector 300 by facilitating a stable positioning of the post 340 with respect to the coupler 330 prior to and while the connector 300 is installed. However, the placement of the internal surface feature 332 of the coupler 330 into the annular detent 349 of the post 340 is not requisite for a secure installation of the connector 300. Secure installation of the connector 300 is accomplished by the traction forces generated due to compression of the coaxial cable 10 (shown in FIG. 1) when the connector 300 is pushed, rammed and/or compressed together onto the cable 10 and the location of the internal surface feature 332 of the coupler 330 which precludes the coupler 330 from axially moving past the external surface feature 342 of the post 340 when the connector 300 is installed.

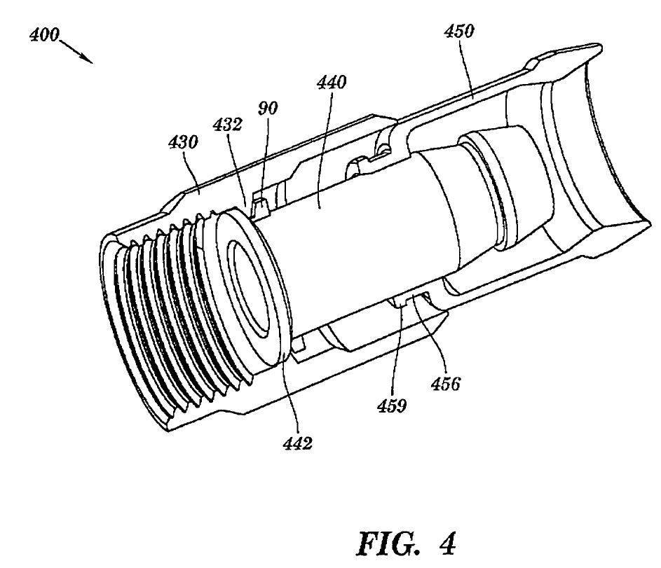

Referring still further to the drawings, FIG. 4 depicts a cut-away perspective view of an embodiment of a connector 400, in accordance with the present invention. The connector 400 may include a coupler 430, a post 440, a connector body 450 and a seal ring 90. The connector body 450 may include a collar 456 having a lip 459 at its edge. The lip 459 may abut the ring seal 90 halting axial progression of the connector body 450 during installation. In addition, the ring seal 90, such as an O-ring or other annular seal, may be positioned on the post 440 proximate the external surface feature 342, such as a flange. Moreover, the internal surface feature 432 of the coupler 430 may be positioned between the ring seal 90 and the external surface feature 442 of the post 440 facilitating an annular seal between the components. The placement of the internal surface feature 432 between the ring seal 90 and the external surface feature 342 of the post 340 may also assist the installation operation of the connector 400 by facilitating a stable positioning of the post 440 with respect to the coupler 430 prior to and while the connector 400 is installed. However, the placement of the internal surface feature 432 of the coupler 430 between the ring seal 90 and the external surface feature 432 of the post 340 is not requisite for a secure installation of the connector 400. The connector 400 relies on traction forces between the cable 10 (shown in FIG. 10) and the connector body 450 working in conjunction with the post 440 to maintain a secure connection, wherein the coupler 430 fastened in the connection by the location of the internal surface feature 432 that prevents the coupler 430 from moving axially beyond the external surface feature 442 of the post 440 when the connector 400 is installed.

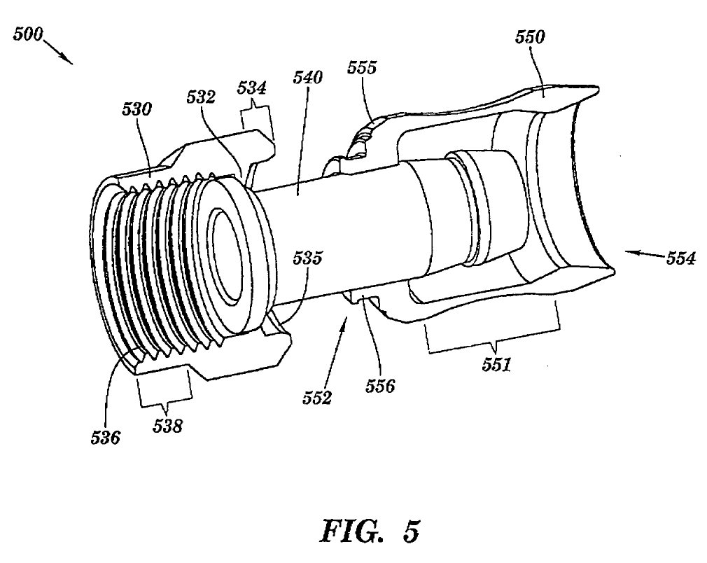

With continued reference to the drawings, FIG. 5 depicts a cut-away perspective view of an embodiment of a connector 500, in accordance with the present invention. The connector 500 may include a coupler 530, a post 540 and a connector body 550. The coupler 530 may include an internal surface feature 532 which may partially terminate an aperture framed by an extended annular sleeve 534. In addition, the coupler 530 may include a chamfer 534 on the aperture surface extending internally from the end of the extended annular sleeve 534. Further, the coupler 530 may have a threaded internal surface 536 for advancing the connector 500 onto an interface port 20 (shown in FIG. 1). Furthermore, the coupler 530 may have an extended cylindrical section 538 on the threaded end of the coupler facilitating deep threaded advancement of the coupler 530 onto an interface port 20. Moreover, the connector body 550 may include a concaved portion 551. Still further, the connector body 550 may include an external surface 555, wherein a portion of the external surface 555 accommodates a second axial opening extending from the second end 554 having a second diameter large enough to facilitate the reception of the coaxial cable 10 (shown n FIG. 1). Additionally, the connector body 550 may include a ring-like collar 556 extending from the first end 552 of the connector body and having a first axial opening with a first diameter configured to slidably engage the post 540.

A method for fastening a connector 100 and a coaxial cable 10 is now described with reference to FIG. 1 which depicts a cut-away perspective view of an embodiment of a connector 100. A coaxial cable 10 may be prepared for connector 100 attachment. Preparation of the coaxial cable 10 may involve removing the protective outer jacket 12 and drawing back the conductive grounding shield 14 to expose a portion of the interior dielectric 16. Further preparation of the embodied coaxial cable 10 may include stripping the dielectric 16 to expose a portion of the center conductor 18. Various other preparatory configurations of coaxial cable 10 may be employed for use with connector 100 in accordance with standard broadband communications technology and equipment. For example, the protective outer jacket 12 may be folded over and drawn back along with the conductive grounding sheath 14 exposing a portion of the dielectric 16.

With continued reference to FIG. 1 and additional reference to FIG. 2, additional depiction of a method for fastening an embodiment of a connector 100 and a coaxial cable 10 is further described. A connector 100 including a post 40 having an external surface feature 42 may be provided. Moreover, the provided connector may include a connector body 50 having an internal surface 53 and an external surface 55. The internal surface 53 of the connector body 50 may be slidably positioned on the post 40 during installation. Furthermore, the provided connector may include a coupler 30 configured with an extended annular sleeve 34 and an internal surface feature 32. The internal surface feature 32 may be configured to operably engage the external surface feature 42 of the post 40 and separate the connector body 40 from the external surface feature 42 of the post 40.

Fastening of the connector 100 may be further attained by positioning the post 40 onto the coaxial cable 10. The positioning of the post 40 onto the cable 10 may be accomplished by insetting the connector 100 onto the coaxial cable 10 in a first pre-installed position 80 such that an end of post 40 is inserted under the conductive grounding sheath or shield 14 of the cable 10 and around the dielectric 16 thereof. Where the post 40 is comprised of conductive material, a grounding connection may be achieved between the received conductive grounding shield 14 of coaxial cable 10 and the inserted post 40. Furthermore, the positioning of the post 40 onto the cable 10 may be effected by hand, wherein a person may hand insert the post 40 onto and over the dielectric 16 of the cable 10 and under the conductive grounding sheath 14 and protective outer jacket 18 layers thereof.

Further methodology for fastening an embodiment of the connector 100 and a coaxial cable 10 may include, compressing the connector 100 to facilitate slidable movement of the external surface 55 of the connector body 50 into at least a portion of the extended annular sleeve 34 of the coupler 30 as the cable 10 as pushed further onto the post rendering a compression seal of the cable 10 between the internal surface 53 of the connector body 50 and the post 40. The compressing of the connector 100 may be accomplished with the assistance of a compression tool having increased mechanical advantage. Accordingly the compression tool may be designed to to engage the connector 100 and force the connector 100 further onto the cable 10 generating increased traction forces between the cable 10 and components of the connector 100 and rendering a substantially sealed binding of the cable 10 and the connector 100. Once compressed into a second installed position 84, the connector 100 may be securely positioned axially with respect to the cable 10. However, when the connector is compressed into a second installed position 84 the coupler 30 may retain rotational freedom and may be threaded onto an interface port.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A coaxial cable connector comprising:
a coupler, including an internal surface feature;
a post, having an external surface feature configured to operably engage the internal surface feature of the coupler; and
a connector body, including a collar for slidably engaging the post, said connector body operatively securing the cable as the cable is received and compressed against the connector body and the post;
wherein the connector body is positioned along the post in a first pre-installed position such that during installation the connector body slidably moves toward the coupler to a second installed position where the connector body is separated from the external feature of the post by the internal surface feature of the coupler.

2. The connector of claim 1, wherein the coupler includes an extended annular sleeve.

3. The connector of claim 1, wherein the coupler is a specially formed threaded nut.

4. The connector of claim 1, wherein the internal surface feature of the coupler is a protruded annular rim.

5. The connector of claim 1, wherein the external surface feature of the post is a flange.

6. The connector of claim 2, wherein an external surface of the connector body is configured to slidably engage at least a portion of the extended annular sleeve of the coupler.

7. The connector of claim 1, wherein an internal surface of the connector body is slidably positioned on the post during installation.

8. The connector of claim 1, wherein slidable movement of the connector body during installation and positioning of the connector in a second installed position is effected by a compression tool.

9. A coaxial cable connector comprising:
a coupler, having an extended annular sleeve, wherein an internal surface of the coupler includes a surface feature;
a post, having an external surface feature configured to operably engage the surface feature of the coupler; and
a connector body, having an internal surface and an external surface, the external surface configured to slidably engage at least a portion of the extended annular sleeve, and the internal surface slidably positioned on the post during installation, wherein the surface feature of the coupler prevents the connector body from engaging the external feature of the post.

10. The connector of claim 9, wherein the surface feature of the coupler is an annular rim.

11. The connector of claim 9, wherein the external surface feature of the post is a flange.

12. The connector of claim 9, wherein in the connector body includes a collar for slidably engaging the post.

13. The connector of claim 9, wherein the connector body operatively secures the cable as the cable is received and compressed against the connector body and the post.

14. The connector of claim 9, wherein axial movement of the post and the coupler is secured in both directions with respect to the connector body when the connector is secured in a second installed position.

15. The connector of claim 9, wherein the connector is slidably compressed by a compression tool having increased mechanical advantage.

16. A coaxial cable connector comprising:
a connector body, having a first end and a second end, the second end configured for receiving the cable; and
a post operating with a coupler, wherein the post is slidably mounted with the connector body in a first pre-installed position, and wherein axial movement of said post and coupler is restrained in both directions with respect to said connector body without engagement by the post or coupler with an external protrusion on the first end of the connector body when the post and coupler are slidably moved to a second installed position causing the cable to compress against the post and connector body securely retaining the cable.

17. The connector of claim 16, wherein the coupler includes an internal protrusion.

18. The connector of claim 17, wherein the post includes an external surface feature.

19. The connector of claim 18, wherein the internal protrusion of the coupler operably engages external surface feature of the post.

20. The connector of claim 16, wherein the coupler includes an extended annular sleeve.

21. The connector of claim 20, wherein the coupler is a specially formed threaded nut.

22. The connector of claim 20, wherein an external surface of the connector body is configured to slidably engage at least a portion of the extended annular sleeve of the coupler.

23. The connector of claim 16, wherein slidable movement of the connector body and compression of the cable during positioning of the connector in a second installed position is effected by a compression tool.

24. A coaxial cable connector comprising:
a post, having a flanged end:
a coupler, having an elongated aperture partially terminated by a surface feature, wherein the surface feature contacts the post flange;
a connector body, having a section proximate the coupler and a section distal the coupler when installed on the cable, the proximate section having a first axial opening with a first diameter and the distal section having a second axial opening with a second diameter larger than the first diameter; and
means for facilitating a final secure positioning of the coupler onto the connector body such that the coupler engages a portion of the connector body accommodating the larger second diameter.

25. A method for fastening a connector and a coaxial cable, said method comprising:
a. providing a connector, including a post having an external surface feature, a connector body having internal surface and an external surface, the internal surface slidably positioned on the post during installation, and a coupler configured with an extended annular sleeve and an internal surface feature, the internal surface feature configured to operably engage the external surface feature of the post and separate the connector body from the external surface feature of the post;
b. positioning the post onto a portion of the cable; and
c. compressing the connector to facilitate slidable movement of the external surface of the connector body into at least a portion of the extended annular sleeve of the coupler as the cable is pushed onto the post rendering a compression seal of the cable between the internal surface of the connector body and the post.

26. The method of claim 25, further including preparing the cable of initial placement on the connector in a first pre-installed position.

27. The method of claim 25, further comprising securing the connector in a second installed position, wherein traction forces between the cable, the internal surface of the connector body, and the post facilitate the secure positioning and retention of the cable on the connector.

28. The method of claim 25, wherein compressing the connector is effected by a compression tool utilizing increased mechanical advantage.
